(19) United States
(12) Patent Application Publication
(10) Pub. No.: US 2014/0372208 A1
(43) Pub. Date: Dec. 18, 2014

(54) DYNAMIC BLOCKING OF TARGETED ADVERTISEMENTS BASED ON USER EVENT OCCURRENCES

(71) Applicant: ECHOSTAR TECHNOLOGIES L.L.C., Englewood, CO (US)

(72) Inventor: Nicholas B. Newell, Highlands Ranch, CO (US)

(21) Appl. No.: 13/916,922

(22) Filed: Jun. 13, 2013

(51) Int. Cl. G06Q 30/02

(52) U.S. Cl. CPC G06Q 30/0251
USPC 705/14.49

(57) ABSTRACT

A targeted advertising method is presented here. The method receives, at a targeted advertising management system, an incident report for a user. The incident report indicates an event occurrence that involves the user. The method continues by obtaining advertisement blackout criteria based on the event occurrence, and communicating the advertisement blackout criteria to a presentation device associated with the user.

### TECHNICAL FIELD

Embodiments of the subject matter described herein relate generally to systems that manage the electronic delivery of targeted advertisements. More particularly, embodiments of the subject matter relate to a technique for selectively blocking the presentation of targeted advertisements directed to a user in response to events or incidents that involve the user, such as product purchases or a change in user status.

### BACKGROUND

Most television viewers now receive their video signals through a content aggregator such as a cable or satellite television provider. In a typical scenario, encoded audio/video signals are sent via a cable or wireless data link to the viewer's home, where the signals are ultimately decoded in a video services receiver (e.g., a set-top box (STB) or other consumer device). In other scenarios, encoded audio/video signals are sent to an electronic presentation device that is owned, used, or otherwise accessed by a user, such as a smartphone device, a computer, a vehicle-based entertainment system, or a portable video game device. Regardless of the delivery mechanism and the presentation device platform, the decoded signals can be viewed on an appropriate display as desired by the viewer. Most video service providers include commercials, advertisements, and/or marketing content interspersed between segments of program content, as is well understood.

Targeted advertising campaigns attempt to deliver advertising content to viewers in an intelligent manner that is dictated by certain characteristics of the viewers. For example, targeted advertisements directed to sports cars can be selectively run during sporting event programming or directed to certain households or neighborhoods having a high population of viewers that are likely to be in the market for automobiles. As another example, web-based targeted advertising can be very individualized and customized such that specific advertisements are directed to a user's web browser in response to that user's browsing history. In the context of a video services system that utilizes video receivers installed at subscriber premises, advertising can be customized on a receiver-by-receiver basis in a fairly straightforward manner.

Although traditional targeted advertising techniques can be helpful in many situations, they can be wasteful and ineffective if they deliver irrelevant, outdated, or stale advertisements to a user. For example, if a targeted advertising system determines that a user has been visiting the Acme Motor Car website and/or dealership, then the system may assume that the user is interested in an Acme branded vehicle and, therefore, deliver Acme Motor Car advertisements to the user. Assume, however, that the user eventually buys a vehicle (whether or not an Acme branded vehicle). A targeted advertising system that continues to flood that user with new car advertisements is no longer functioning in an efficient and effective manner, because the user is no longer in the market for a new car. Similarly, a person may be provided with a number of targeted advertisements related to an upcoming election. If, however, that person has already voted or has already submitted an early mail-in ballot, then any advertisements related to the election are stale, at least with respect to that particular user.

It is therefore desirable to provide a system and related methodologies that address the shortcomings of traditional targeted advertising mentioned above. Furthermore, other desirable features and characteristics will become apparent from the subsequent detailed description and the appended claims, taken in conjunction with the accompanying drawings and the foregoing technical field and background.

### BRIEF SUMMARY

A targeted advertising method is presented here. The method may begin by receiving, at a targeted advertising management system, an incident report for a user. The incident report indicates an event occurrence that involves the user. The method may continue by obtaining advertisement blackout criteria based on the event occurrence, and by communicating the advertisement blackout criteria to a presentation device associated with the user.

Also provided is a targeted advertising management system. The system includes a communication interface configured to communicate data between the targeted advertising management system and an electronic device of a user. The communication interface is further configured to receive an incident report for the user, wherein the incident report indicates an event occurrence involving the user. The system also includes a processor coupled to the communication interface. The processor is configured to obtain advertisement blackout criteria corresponding to the event occurrence, and to control the communication interface such that the communication interface communicates the advertisement blackout criteria to the electronic device.

Another targeted advertising method is also presented here. The method may begin by providing a targeted advertisement intended for presentation to a user. The method continues by receiving an incident report that indicates an event occurrence involving the user, obtaining advertisement blackout criteria based on characteristics of the event occurrence, and blocking presentation of the targeted advertisement when characteristics of the targeted advertisement satisfy the advertisement blackout criteria.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates an exemplary embodiment of an environment that supports targeted advertising;

FIG. 2 is a flow chart that illustrates an exemplary embodiment of a process related to the dynamic blocking of targeted advertisement; and

FIG. 3 is a flow chart that illustrates an exemplary embodiment of a process related to the management of targeted advertisements.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. Moreover, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The exemplary embodiments described herein relate to a computer-based targeted advertising system, which may be deployed in the context of a video delivery system such as a satellite or cable television system, a web-enabled mobile device or any web-enabled computer system, a vehicle-based entertainment system, or the like. The disclosed subject matter relates to a methodology for blocking or otherwise inhibiting the presentation of targeted advertising that has already been designated for an end user, such that the end user is not presented with advertising material that is no longer relevant to his or her interests, needs, or desires. The targeted advertisements that are candidates for blocking will typically be advertisements that have already been delivered to the user's presentation device and advertisements that have already been presented to the user at least once. More specifically, the disclosed methodology utilizes a categorization or classification scheme for the targeted advertisements, along with an event monitoring service or system that determines (in an ongoing manner) whether or not the targeted user has experienced an event, status change, or condition that might render certain targeted advertisements moot, irrelevant, or less appealing. The targeted advertising management approach described herein improves the effectiveness of targeted advertisements and adds value to advertisers by inhibiting, restricting, or preventing the playback of advertisements that are no longer useful or interesting to the user.

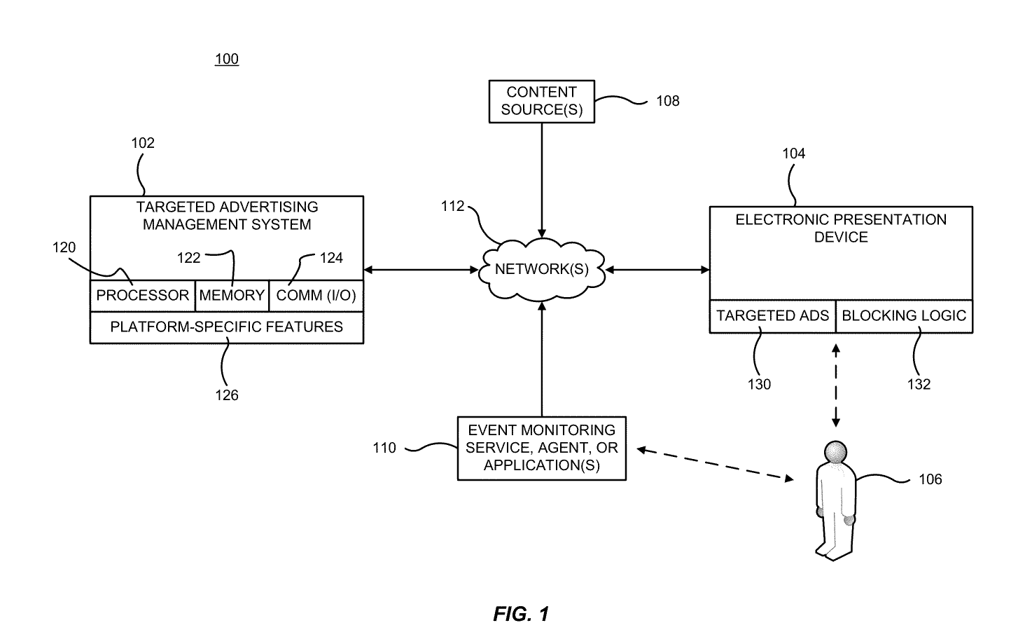

Turning now to the drawings, FIG. 1 is a block diagram that illustrates an exemplary embodiment of an environment 100 that supports targeted advertising. For the sake of brevity and clarity, the environment 100 is depicted in a generalized and simplified manner. It should be appreciated that the environment 100 may (and typically will) include additional components, subsystems, and elements that are not shown in FIG. 1.

The illustrated embodiment of the environment 100 generally includes, without limitation: a targeted advertising management system 102; an electronic presentation device 104 that is owned by, assigned to, viewed by, or otherwise associated with a user 106; at least one content source 108; and at least one event monitoring service, agent, system, application, and/or provider (individually and collectively referred to herein as the event monitoring service 110). The primary elements of the environment 100 are suitably configured to communicate with one another via one or more data communication networks (individually and collectively referred to herein as the network 112).

The network 112 is intended to generally represent any all all possible implementations that might be configured to support the data communication capabilities of the environment 100. In this regard, the environment 100 may utilize satellite-based data delivery, cable-based data delivery, cellular-based data delivery, Internet-based data delivery, or any combination thereof. Moreover, the environment 100 may utilize any type of data communication network, along with any applicable data transmission techniques, protocols, and architectures. The specific details of such delivery systems and related data communication protocols will not be described here. That said, certain embodiments of the environment 100 are deployed in the context of a video services delivery system, wherein the targeted advertising management system 102 is implemented at one or more backend network systems that provide encoded audio/video data to client devices, such as video services receivers, smartphones, tablet computers, etc. In such a context, the presentation device 104 may be: a video services receiver (a set-top box) located at the home of the user 106; a computer system operated by the user 106; a mobile electronic device operated by the user 106; or the like.

The targeted advertising management system 102 is implemented as one or more computer-based or processor-based devices. For example, the targeted advertising management system 102 could be realized using any suitably configured computer architecture or platform that includes, without limitation: a processor 120; an appropriate amount of memory 122; a communication interface 124; and any number of platform-specific features 126. The processor 120 is configured to manage, perform, and/or execute the various methods, functions, and operations described in more detail below, in response to applicable software applications, programs, and code executed by the system 102. The memory 122 supports the functionality of the targeted advertising management system 102, and the memory 122 may be utilized to store computer-executable instructions that perform the various methods, functions, and operations described in more detail below. The communication interface 124 is configured to support data communication (incoming and outgoing as needed) with the presentation device 104, the content source 108, and the event monitoring service 110. In this regard, the communication interface 124 is preferably configured to support the data communication techniques and protocols needed for compatibility with the network 112. The platform-specific features 126 are associated with other functions and operations that may be specific to the particular implementation of the targeted advertising management system 102. For example, if the system 102 is implemented in the context of a backend server of a video services system, then the platform-specific features 126 may include a variety of video processing and encoding functions.

As mentioned previously, the presentation device 104 may be realized as any processor-based or computer-based electronic device. For example, the presentation device 104 may be any of the following, without limitation: a video services receiver; a television set; a cellular or other mobile telephone device; a video game system (mobile or otherwise); a digital media player; a medical device; a global positioning device; a navigation device; a toy or game platform; or a computer device (desktop, laptop, tablet, or the like). Although not shown in FIG. 1, the presentation device 104 may include a processor, a suitable amount of memory, a communication interface, and platform-specific features, as generally described above for the targeted advertising management system 102. The memory of the presentation device 104 may be used to store targeted advertisements 130 that are intended for the user 106 (or intended for the presentation device 104 itself, or for any other user who is assumed to be linked or otherwise associated with the presentation device 104, such as another member of the user's family). The presentation device 104 may also include or cooperate with blocking logic 132 that performs at least some of the targeted advertising management operations described herein. In certain embodiments, the blocking logic 132 may be executed or performed by the processor of the presentation device 104.

During typical operation, the presentation device 104 receives programming (such as primary program content interspersed with segments of secondary content, commercials, and/or targeted advertising), signaling information, and/or other data via the network 112. The presentation device 104 then demodulates, decompresses, descrambles, and/or otherwise processes the received digital data, and converts the received data to suitably formatted video signals that can be rendered for viewing by the user 106. The targeted advertisements 130 may be provided to the presentation device 104 at any time for storage and subsequent playback. As explained in more detail below, the stored targeted advertisements 130 may be analyzed or processed using the blocking logic 132 to determine whether or not the presentation device 104 should continue presenting the targeted advertisements 130 to the user 106.

In some embodiments, the content source 108 provides media content (such as video programming, advertising content, music programming, and other audio, video, or audiovisual content) to the targeted advertising management system 102 and/or to the presentation device 104 as needed. For the sake of brevity, conventional techniques related to video/media communication systems, video/media broadcasting systems, data transmission, signaling, network control, and other functional aspects of the systems (and the individual operating components of the systems) are not described in detail herein. It should be appreciated that the content source 108 may be realized as a physically distinct and remote device relative to the targeted advertising management system 102, or it may be integrally implemented with the system 102. Moreover, a physically distinct content source 108 may communicate with the system 102 directly or via the network 112 if so desired.

The event monitoring service 110 illustrated in FIG. 1 represents one or more systems, entities, providers, agents, and/or applications (along with the associated hardware, architecture, and platforms) that cooperate with the targeted advertising management system 102 and the presentation device 104 to implement the targeted advertising blocking scheme. The service 110 monitors user behavior, conduct, activity, purchases, status, condition, and/or any detectable characteristics that might influence the level of interest in targeted advertisements (more specifically, targeted advertisements that have already been presented to the user at least once, or targeted advertisements that have already been delivered to the presentation device 104 and earmarked for the user). For example, the service 110 may be associated with a customer loyalty program at a store frequented by the user 106, such that the service 110 has knowledge of the user's purchases in an ongoing manner. As another example, the service 110 could be tied into a network of business, vendors, or companies such that the service 110 is notified whenever the user 106 purchases a product, service, or item from a monitored entity in the network. As another example, the service 110 could be linked to government agencies or departments (e.g., the department of motor vehicles, the property tax collector, the secretary of state, or the voting or election board), such that the service 110 is informed of certain status updates that involve the user 106. It should be appreciated that the event monitoring service 110 need not (and usually will not) be maintained or associated with only one entity. Rather, the environment 100 may cooperate with any number of different event monitoring services 110, which may be provided by a plurality of different sources. Moreover, in some embodiments, the functionality of the event monitoring service 110 could be incorporated into the targeted advertising management system 102 and/or the presentation device 104.

The event monitoring service 110 is configured to detect or respond to certain event occurrences that involve the user 106, wherein such event occurrences may be relevant to a targeted advertising scheme for the user 106. More specifically, an event occurrence may indicate that the user 106 is no longer interested in an advertised product, service, or item, or that one or more targeted advertisements would be ineffective going forward (with respect to that particular user 106), or that one or more targeted advertisements would be ignored or disregarded by the user 106 if presented to the user again. Thus, an event occurrence handled by the event monitoring service 110 may include or be associated with any or all of the following, without limitation: a purchase; a donation; a completed voter registration; a completed vehicle registration; a completed voting ballot; an attended event (e.g., a movie, a sporting event, a concert); an address change; a career promotion; a graduation event; checking into a hotel; a change in travel status; a change in geographical location of the user 106; a change in geographical location of the presentation device 104; registering for membership in a group (e.g., an interest group, a trade association, an online user forum, or the like); a change in health status; a change in marital status; or the like. These and other types of event occurrences could be handled by the event monitoring service, and the specific examples provided here are not intended to limit or restrict the application or scope of the disclosed subject matter in any way.

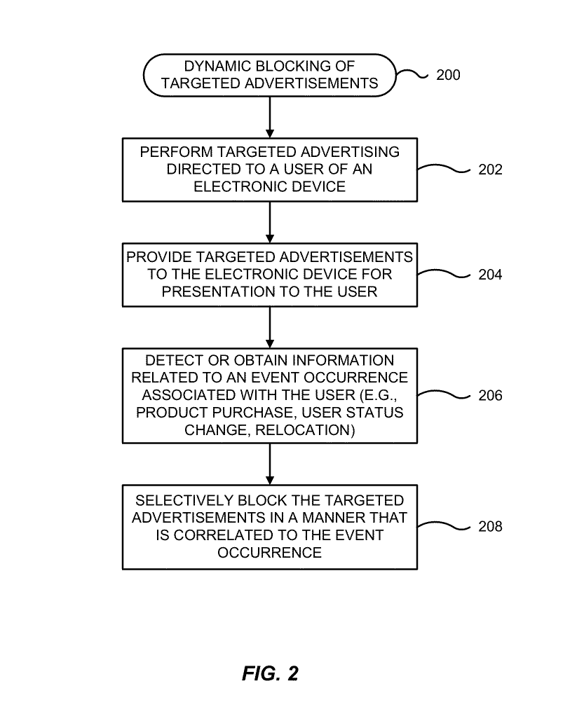

FIG. 2 is a flow chart that illustrates an exemplary embodiment of a process 200 related to the dynamic blocking of targeted advertisement. The process 200 may be performed by a system such as that described above with reference to FIG. 1. The various tasks performed in connection with the process 200 may be performed by software, hardware, firmware, or any combination thereof. For illustrative purposes, the following description of the process 200 may refer to elements mentioned above in connection with FIG. 1, although the environment 100 represents only one particular embodiment that could be used to support the process 200. It should be appreciated that the process 200 may include any number of additional or alternative tasks, the tasks shown in FIG. 2 need not be performed in the illustrated order, and the process 200 may be incorporated into a more comprehensive procedure or process having additional functionality not described in detail herein. Moreover, one or more of the tasks shown in FIG. 2 could be omitted from an embodiment of the process 200 as long as the intended overall functionality remains intact.

The process 200 manages and performs a targeted advertising campaign or scheme, which is directed to a user of an electronic device (task 202). Although not always required, this example assumes that the targeted advertising campaign is carried out in the context of a video delivery services system, and that the targeted advertisements are formatted for presentation by a video services receiver associated with or assigned to the user. The process 200 provides targeted advertisements to the electronic device (task 204). The targeted advertisements are intended for presentation to the user, i.e., they are targeted to that particular user rather than to the general public.

The process 200 may continue with the targeted advertising campaign for any period of time, updating the targeted advertisements as needed, and in accordance with the particular selection protocol or algorithm supported by the system. This example assumes that the process 200 detects or otherwise obtains information that is related to an event occurrence associated with the user of interest (task 206). As explained above, the detected event occurrence may be related to the purchase of an identifiable product, a change in the user's status or condition, etc. In response to the detected event occurrence, the process 200 selectively blocks one or more of the targeted advertisements such that the blocked advertisements are no longer presented to the user (task 208). As one non-limiting example, assume that the targeted advertising campaign has provided promotional commercials for an upcoming concert to the user, and that the user has recently purchased tickets to that particular concert. The purchase transaction for the tickets represents the detected event occurrence. In response to this event occurrence, the process 200 intelligently blocks the promotional commercials, with the assumption that the user need not be further encouraged or reminded to buy tickets for the concert.

Blocking of targeted advertisements in accordance with the process 200 may be accomplished using metadata, encoded information, or other data associated with the targeted advertisements. In certain implementations, the blocking methodology relies on an advertisement categorization or classification scheme that enables the targeted advertising management system to identify advertisements to be blocked in response to detected event occurrences that have some correlation with the context, subject matter, advertising goal, or content of the targeted advertisements. Accordingly, the targeted advertising management system is suitably configured for compatibility with the advertisement categorization/classification scheme. To this end, each targeted advertisement that is compatible with the blocking methodology has one or more advertisement descriptors assigned thereto, wherein the advertisement descriptors serve to characterize, classify, categorize, tag, describe, or summarize the advertisement in some manner. In certain embodiments, the advertisement descriptors are arranged in a hierarchical or tiered manner, i.e., “upper level” or “higher order” descriptors may be associated with any number of “lower level” or “lower order” descriptors, arranged in any number of levels/orders. The relevant advertisement descriptors could be assigned to each individual advertisement, or the designated descriptors for a given advertisement could be selected from a list, table, or matrix of available descriptors.

As one non-limiting example, the targeted advertisements could be classified in accordance with the following hierarchical scheme:
01 Vehicle
   01 Automobile
      01 Brand_{—}1
      02 Brand_{—}2
      03 Brand_{—}3
   02 Boat
   03 Motorcycle
   04 Bicycle
   05 Skateboard
02 Personal Care
   01 Shampoo
   02 Soap
   03 Shaving Supplies
      01 Razor Blades
      02 Shaving Cream
         Using the above example, a targeted advertisement promoting a new car offered by “Brand_{—}2” may be classified using the descriptors 01, 01, and 02 (in that hierarchical order), or using a single identifier that includes all of the relevant descriptors, such as 01.01.02, 010102, etc. In practice, there can be any number of upper level descriptors in addition to “Vehicle” and “Personal Care”, and the upper level descriptors need not be related to consumer goods or services. For instance, an upper level descriptor may be as follows: Political Affiliation; Retired; Male; Female; College Student; Music Lover; Dish Network Subscriber; or the like. In practice, any number of advertisement descriptors and sub-descriptors (or no sub-descriptors) could be supported as needed to accurately characterize the targeted advertisements.

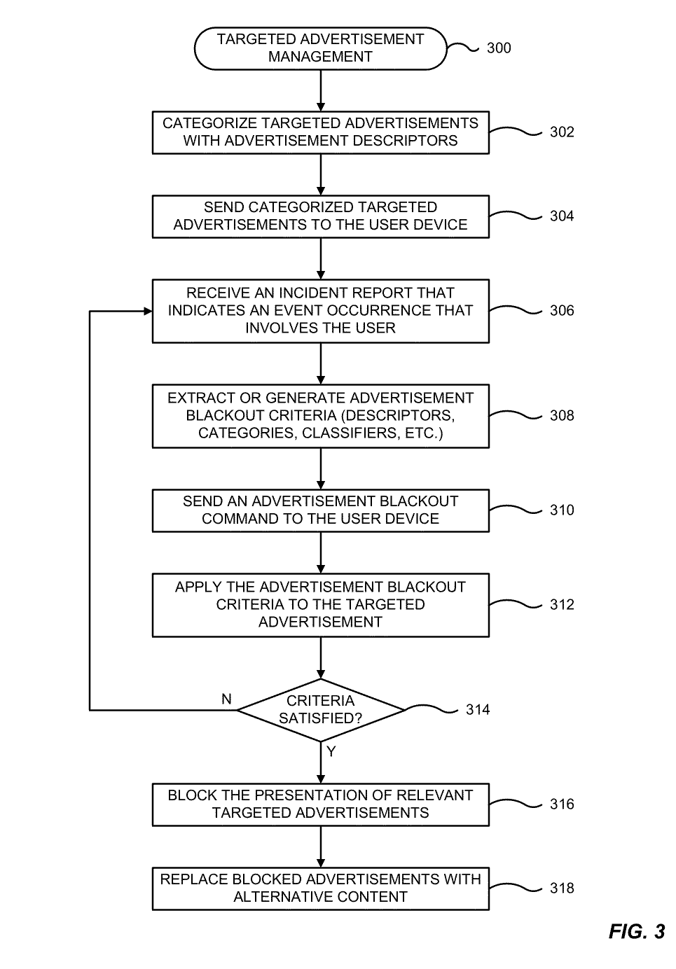

FIG. 3 is a flow chart that illustrates an exemplary embodiment of a process 300 related to the management of targeted advertisements. The process 300 may be performed by a system such as that described above with reference to FIG. 1. The various tasks performed in connection with the process 300 may be performed by software, hardware, firmware, or any combination thereof. For illustrative purposes, the following description of the process 300 may refer to elements mentioned above in connection with FIG. 1, although the environment 100 represents only one particular embodiment that could be used to support the process 300. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 may be performed in conjunction with the process 200, or it may be considered to be a more detailed implementation of the process 200. The following description of the process 300 assumes that the system is suitably configured to support the use of advertisement descriptors and compatible blackout descriptors for purposes of regulating which targeted advertisements are blocked at the presentation device.

The process 300 assumes that targeted advertisements have been categorized with applicable advertisement descriptors (task 302). The categorized or tagged advertisements are sent, delivered, or otherwise provided to the user presentation device (task 304) for presentation to the user at an appropriate time. This example assumes that the process 300 eventually receives an incident report for the user (task 306). The incident report indicates, describes, or details the specifics of a detected event occurrence that involves the user somehow. In certain situations, the incident report originates from an event monitoring service, and is sent to the targeted advertising management system. In other scenarios, the incident report originates from the presentation device itself. In yet other situations, the incident report is generated from a system or device (other than the presentation device) under the control of the user or another person.

The process 300 continues by extracting or generating advertisement blackout criteria, based on characteristics of the reported event occurrence (task 308). The blackout criteria is formatted to selectively block the presentation of targeted advertisements (at the presentation device) that satisfy the criteria. In some embodiments, the incident report will include or identify at least some of the blackout criteria to be used in response to the reported event occurrence. In such embodiments, the blackout criteria is explicitly provided in the incident report. In other embodiments, at least some of the blackout criteria is determined by analyzing the content of the incident report and/or by considering certain conditions or operating parameters that relate to the received incident report. In other words, the blackout criteria is only implicitly defined or provided by the incident report.

Task 308 obtains advertisement blackout criteria associated with the reported event occurrence, and the process 300 handles the advertisement blackout criteria as needed. For this particular example, the blackout criteria corresponds to blackout descriptors, which may be arranged in a hierarchical structure. In this regard, the blackout descriptors may be compatible with the advertisement descriptors mentioned above. Indeed, the set of available blackout descriptors and the manner in which the blackout descriptors are related to one another may be identical to the set of available advertisement descriptors that are used to characterize the targeted advertisements. For this example, the advertisement blackout criteria includes at least one blackout descriptor selected from a set of predefined descriptors maintained by the targeted advertisement management system, and each targeted advertisement regulated by the targeted advertisement management system is characterized by at least one advertisement descriptor selected from the same set of predefined descriptors.

The process 300 may continue by preparing and sending an advertisement blackout command to the user presentation device (task 310). The blackout command includes or otherwise identifies the blackout criteria obtained at task 308. Thus, the blackout criteria is communicated to the presentation device by way of the blackout command. This example assumes that the presentation device successfully receives and processes the blackout command. This allows the process 300 to retrieve and apply the advertisement blackout criteria at the presentation device (task 312). More specifically, the received blackout criteria is applied against the targeted advertisements maintained at the presentation device to determine whether or not any of the targeted advertisements should be blocked (query task 314).

For the case where the presentation device, a video services receiver, or other local client device includes the functionality of the event monitoring service (as mentioned above), the blackout command may be generated internally and processed in the same manner described here. In other words, the blackout command may be created and consumed by the same client device in certain embodiments. Thus, although the process 300 is described here in the context of a system that communicates the blackout command from one device to another, such communication is not always required.

Blackout commands could be provided to the presentation device in real time (or substantially real time) in response to the detection of a corresponding event occurrence. Alternatively or additionally, blackout commands or a single command with different blackout criteria could be provided to the presentation device at certain designated times, e.g., once a day, once every hour, weekly, etc. In other words, blackout commands may be “held” at the backend system and communicated to the presentation device in a batch format if so desired.

Query task 314 checks whether the blackout criteria is satisfied for a given targeted advertisement. The criteria is satisfied when characteristics of the targeted advertisement correlate with the blackout descriptors. More specifically, the criteria is satisfied when the blackout descriptors conveyed in the blackout command match the advertisement descriptors of a targeted advertisement by at least a threshold amount. For example, if the blackout criteria indicates that the user is no longer interested in home remodeling services, then targeted advertisements that are tagged or labeled with the advertisement descriptor “Construction & Contracting” may be considered to be a match for purposes of satisfying the advertisement blackout criteria. As another example, if the blackout criteria identifies “Vehicle” as a blackout descriptor, then any targeted advertisements that are tagged or labeled with the advertisement descriptor “Vehicle” may be considered to be a match for purposes of satisfying the advertisement blackout criteria.

The algorithm, protocol, and/or mechanism used at query task 314 may vary from one embodiment to another, from one system to another, from one presentation device to another, or the like. In accordance with the simple example presented here, the targeted advertisements and the blackout criteria are compatibly formatted for use with a common list of descriptors, and advertisements are blocked when all of the descriptors match. Alternatively, the process 300 may be designed to block targeted advertisements when at least a threshold number of descriptors match. As yet another example, the process 300 may be designed to block targeted advertisements only when the descriptors match at a certain predetermined tier of the categorization hierarchy.

If the advertisement blackout criteria is not satisfied (the “No” branch of query task 314), then the process 300 may exit or return to an appropriate task, such as task 306. If the blackout criteria is satisfied (the “Yes” branch of query task 314), then the process 300 inhibits, blocks, or prevents the presentation of the relevant targeted advertisements that match or satisfy the criteria (task 316). Task 316 may be implemented at the presentation device in any suitable manner such that targeted advertisements that have been designated or directed to the particular user or presentation device are permanently or temporarily blocked. Permanent blocking could be achieved by deleting the targeted advertisements from the presentation device, or by otherwise preventing presentation of the advertisements for an indefinite period of time. Temporarily blocking could be achieved by providing an expiration period with the advertisement blackout criteria such that the received blackout criteria is effective for only a limited and defined time. After the defined expiration period times out, presentation of the previously blocked advertisements may proceed as usual. In this manner, the process 300 inhibits the presentation of targeted advertisements at the presentation device in a manner that is influenced by or is otherwise in accordance with the applied blackout criteria.

In certain embodiments, the process 300 replaces blocked advertisements with alternative content (task 318). The alternative content may be, without limitation, replacement advertisements (targeted or otherwise), previews or trailers for broadcast content, a poster or any still image, or the like. The presentation device and/or the backend network system may employ any suitable mechanism to replace blocked targeted advertisements with other content.

In practice, the advertisement blackout criteria that is conveyed with the blackout command is specific to the presentation device that receives the command. In other words, targeted advertisements are blocked at the presentation device level in response to the received blackout criteria. In some implementations, however, the advertisement blackout criteria is specific to a particular user. In other words, the blackout criteria also includes at least one user identifier that causes the presentation device to selectively block the presentation of targeted advertisements when the presentation device determines that one of the identified users is likely to be viewing. For example, the presentation device may obtain login data, biometric data (e.g., related to fingerprints, facial features, etc.), confirmation data, or other information that correlates the current and actual user with a user identifier. This technique may be desirable in the context of a video services receiver that provides video programs to different members of a household. The process 300 could be modified as described here to intelligently block the targeted advertisements based on who is actually watching the programming This methodology is particularly useful in situations where the incident reports (see task 306) identify the particular user (or users) associated with the detected event occurrence.

In some embodiments, the system allows the user to directly and explicitly identify at least some of the targeted advertising blackout criteria (via the user interface of the client device, written instructions to the service provider, a web page, or the like). This feature would allow the user to designate which types of targeted advertising will be blocked, independently of the monitored event occurrences. Of course, the host system could be configured to restrict the amount of blocking a given user can designate. For example, the user may be allowed to block only one “category” of targeted advertisements at any time, or the user may be allowed to block targeted advertisements only on certain days or during certain periods of time. In practice, such an “override” feature could be marketed as a value added service at an additional cost to subscribers of a video services provider.

Referring again to FIG. 2, a system environment of the type described herein could utilize any appropriate mechanism, technology, and/or computer-executed application to selectively inhibit the presentation of previously-delivered targeted advertisements. In this regard, FIG. 3 and the related description represent merely one possible embodiment that could be utilized to carry out the general approach for blocking targeted advertisements. It should be appreciated that other implementations are also possible, and that such alternative implementations are contemplated by this disclosure.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A targeted advertising method comprising:
receiving, at a targeted advertising management system, an incident report for a user, the incident report indicating an event occurrence;
obtaining advertisement blackout criteria based on the event occurrence; and
communicating the advertisement blackout criteria to a presentation device associated with the user.

2. The method of claim 1, further comprising:
applying the advertisement blackout criteria at the presentation device; and
inhibiting presentation of at least one targeted advertisement at the presentation device in accordance with the applied advertisement blackout criteria.

3. The method of claim 1, further comprising:
applying the advertisement blackout criteria at the presentation device;
inhibiting presentation of a blocked targeted advertisement at the presentation device, in accordance with the applied advertisement blackout criteria; and
replacing the blocked targeted advertisement with alternative content.

4. The method of claim 1, wherein the obtaining comprises:
extracting at least some of the advertisement blackout criteria from the received incident report.

5. The method of claim 1, wherein the obtaining comprises:
analyzing content of the incident report; and
generating at least some of the advertisement blackout criteria in response to the analyzing.

6. The method of claim 1, wherein:
the advertisement blackout criteria comprises at least one blackout descriptor selected from a plurality of predefined descriptors maintained by the targeted advertisement management system; and
each targeted advertisement regulated by the targeted advertisement management system is characterized by at least one advertisement descriptor selected from the plurality of predefined descriptors.

7. The method of claim 1, wherein the advertisement blackout criteria is specific to the user.

8. The method of claim 1, wherein the advertisement blackout criteria is specific to the presentation device.

9. The method of claim 1, wherein the advertisement blackout criteria comprises an expiration period.

10. The method of claim 1, wherein the incident report originates from the presentation device.

11. The method of claim 1, wherein the incident report originates from an event monitoring service.

12. A targeted advertising management system comprising:
a communication interface configured to communicate data between the targeted advertising management system and an electronic device of a user, and further configured to receive an incident report for the user, the incident report indicating an event occurrence involving the user; and
a processor coupled to the communication interface, wherein the processor is configured to obtain advertisement blackout criteria corresponding to the event occurrence, and to control the communication interface such that the communication interface communicates the advertisement blackout criteria to the electronic device.

13. The system of claim 12, wherein the advertisement blackout criteria is formatted to selectively block presentation of targeted advertisements that satisfy the advertisement blackout criteria.

14. The system of claim 13, wherein the advertisement blackout criteria comprises a plurality of descriptors arranged in a hierarchical structure.

15. The system of claim 12, wherein the processor is configured to extract at least some of the advertisement blackout criteria from the received incident report.

16. The system of claim 12, wherein the advertisement blackout criteria comprises an expiration period.

17. The system of claim 12, wherein the event occurrence comprises a purchase made by the user.

18. A targeted advertising method comprising:
providing a targeted advertisement intended for presentation to a user;
receiving an incident report that indicates an event occurrence involving the user;
obtaining advertisement blackout criteria based on characteristics of the event occurrence; and
blocking presentation of the targeted advertisement when characteristics of the targeted advertisement satisfy the advertisement blackout criteria.

19. The method of claim 18, wherein:
the targeted advertisement has an advertisement descriptor assigned thereto;
the advertisement blackout criteria comprises a blackout descriptor; and
presentation of the targeted advertisement is blocked when the blackout descriptor matches the advertisement descriptor.

20. The method of claim 18, wherein the incident report originates from an event monitoring service.
